(19) United States
(12) Patent Application Publication
(10) Pub. No.: US 2008/0158708 A1
(43) Pub. Date: Jul. 3, 2008

(54) Preparing for servo write

(76) Inventor: Frederick A. Maulion, Muntinlupa (PH)

Correspondence Address: HITACHI C/O WAGNER BLECHER LLP, 123 WESTRIDGE DRIVE, WATSONVILLE, CA, 95076, US

(21) Appl. No.: 11/647,876

(22) Filed: Dec. 29, 2006

(51) Int. Cl. G11B 5/02

(52) U.S. Cl. 360/59

(57) ABSTRACT

Embodiments of the present invention pertain to preparing for servo write. According to one embodiment, a servo write preparation heater is positioned over at least a portion of a surface of a disk. The servo write preparation heater is used to heat the at least portion of the surface of the disk to prepare the surface for servo write.

### TECHNICAL FIELD

Embodiments of the present invention relate to disk drives. More specifically, embodiments of the present invention relate to preparing for servo write.

### BACKGROUND

Typically, data is read from and written to the disk of a disk drive in circular tracks. A “servo pattern” is typically written to a disk for example at the manufacturers to facilitate positioning a read write head for the purpose of reading data from and writing data to the disk. The process of writing the servo pattern to a disk is commonly referred to as “servo write.”

A manufacturing facility may manufacture brand new disk drives or may rework previously manufactured disk drives. A disk, whether brand new or previously manufactured, may have magnetic fields on the disk that can interfere with writing a servo pattern to the disk. For example, any old magnetic fields on a disk prior to writing a servo pattern can lead a controller to being unable to accurately position and maintain the position of a read write head on the tracks defined by the servo pattern. Therefore, before writing a servo pattern on a disk the old magnetic fields are erased from the disks to ensure that the old magnetic fields do not interfere with a controller using the servo write pattern.

### SUMMARY OF THE INVENTION

Embodiments of the present invention pertain to preparing for servo write. According to one embodiment, a servo write preparation heater is positioned over at least a portion of a surface of a disk. The servo write preparation heater is used to heat the at least portion of the surface of the disk to prepare the surface for servo write.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a plan view of a disk drive for facilitating the discussion of various embodiments of the present invention.

FIG. 2 depicts a block diagram of an apparatus for preparing for servo write, according to one embodiment.

FIG. 3 depicts a single heater in relation to a single disk associated with an assembled disk drive, according to one embodiment.

FIG. 4 depicts multiple heaters in relation to a stack of disks that are not assembled into a disk drive, according to one embodiment.

FIG. 5 depicts a flowchart that describes a method of preparing for servo write, according to one embodiment.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

Manufacturing disk drives is very competitive business. Disk drives can be sold at lower prices when they are manufactured more quickly. Therefore, the company that can manufacture disk drives the quickest has a significant competitive advantage over their competitors.

Erasing the magnetic fields from a disk prior to performing servo write can be time consuming. According to one embodiment, at least a portion of a disk's surface is heated to prepare the surface for servo write. For example, the disk's surface can be erased more quickly when the disk's surface is heated. Further, a smaller magnetic field can be used to erase the disk's surface when the disk's surface is heated.

### Disk Drive

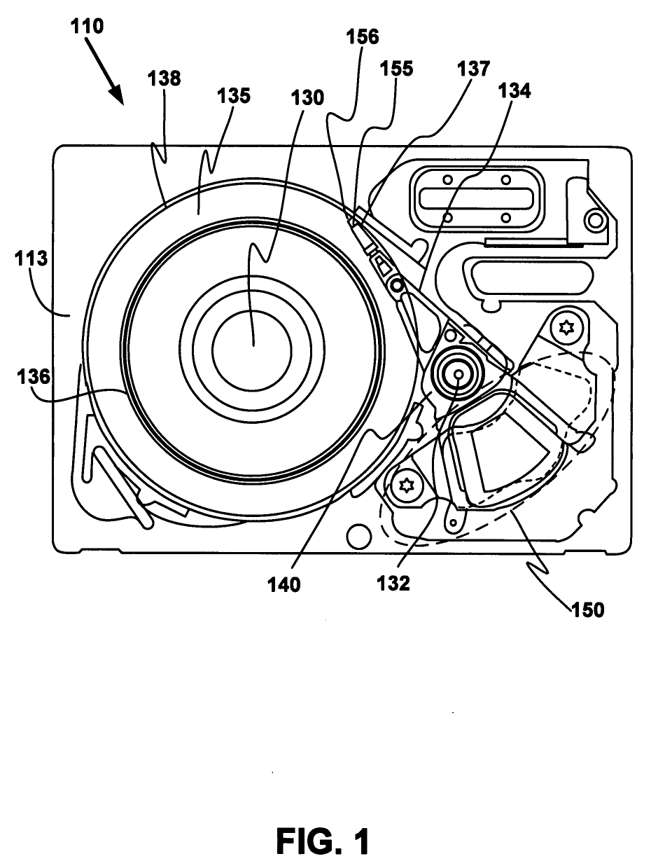

FIG. 1 depicts a plan view of a disk drive for facilitating the discussion of various embodiments of the present invention. The disk drive 110 includes a base casting 113, a motor hub assembly 130, a disk 138, actuator shaft 132, actuator arm 134, suspension assembly 137, a hub 140, voice coil motor 150, a magnetic head 156, and a slider 155.

The components are assembled into a base casting 113, which provides attachment and registration points for components and sub assemblies. A plurality of suspension assemblies 137 (one shown) can be attached to the actuator arms 134 (one shown) in the form of a comb. A plurality of transducer heads or sliders 155 (one shown) can be attached respectively to the suspension assemblies 137. Sliders 155 are located proximate to the disk 138's surface 135 for reading and writing data with magnetic heads 156 (one shown). The rotary voice coil motor 150 rotates actuator arms 135 about the actuator shaft 132 in order to move the suspension assemblies 150 to the desired radial position on a disk 138. The actuator shaft 132, hub 140, actuator arms 134, and voice coil motor 150 may be referred to collectively as a rotary actuator assembly.

Data is recorded onto the disk's surface 135 in a pattern of concentric rings known as data tracks 136. The disk's surface 135 is spun at high speed by means of a motor-hub assembly 130. Data tracks 136 are recorded onto spinning disk surfaces 135 by means of magnetic heads 156, which typically reside at the end of sliders 155.

FIG. 1 being a plan view shows only one head, slider and disk surface combination. One skilled in the art understands that what is described for one head-disk combination applies to multiple head-disk combinations, such as disk stacks (not shown). However, for purposes of brevity and clarity, FIG. 1 only shows one head and one disk surface.

### Servo Write

Typically, data is read from and written to a disk of a disk drive in circular tracks. Pieces of circular track positioning information (CTPI) are typically written to a disk for example at the manufacturers, to facilitate reading data from and writing data to the disk. The pieces of CTPI can form a pattern. The pieces of CTPI are commonly referred to as “servo bursts” and the pattern is commonly referred to as a “servo pattern.” The servo pattern is used during operation of the disk drive to ensure that the head of the disk drive is centered over the desired track of data. For example, the servo pattern is used to determine where to write data to and where to read data from. The process of writing the servo pattern to a disk is commonly referred to as “servo write.”

### Curie Point

Electronic data can be stored on a disk in the form of magnetic field(s). Disks typically include ferromagnetic materials which have magnetic properties. The “Curie point” is a temperature at which the alignment of magnetic fields on ferromagnetic material is destroyed. As the temperature of a ferromagnetic material rises and approaches the ferromagnetic material's Curie point, the material's ability to maintain a magnetic field weakens. According to one embodiment, heating at least a portion of a disk's surface to approximately the Curie point is used as a part of erasing data from the disk's surface.

Different ferromagnetic materials have different Curie points. For example, Iron (Fe) has a Curie point of 1043 Kelvin (K) and Cobalt has a Curie point of 1388 K. The Curie point used to erase data from a particular disk is determined based on one or more materials that the disk is made of.

### Erasing

A magnetic field can be applied to a disk's surface to erase whatever magnetic field or fields were originally on the disk's surface, for example, when the temperature of the disk's surface is approximately at the Curie point. A write element can be used to apply the new magnetic field to the heated portion of the disk's surface. The write element may be or may not be associated with the disk drive's read write head. The disk's surface can be heated to a temperature that is in proximity to the Curie point that will not cause damage to the disk. The disk's surface can be heated to a temperature that is below and in proximity to the Curie point. A subset or all of the data can be erased from a heated portion of the disk. A subset or all of the data can be erased from the disk.

### Apparatus for Preparing for Servo Write

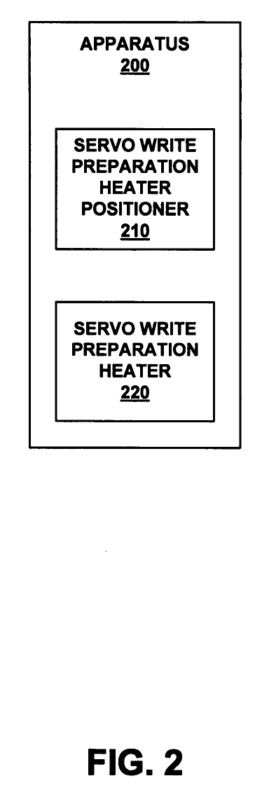

FIG. 2 depicts a block diagram of an apparatus for preparing for servo write, according to one embodiment. The blocks can represent logic and/or physical entities, among other things. The number of pieces of logic/physical entities represented by the blocks in FIG. 6 may be changed. For example, multiple pieces of logic/physical entities represented by one block may be separated or pieces of logic/physical entities represented by two or more blocks may be combined. The blocks may be implemented with hardware, software, firmware or a combination thereof.

As depicted in FIG. 2, the apparatus 200 includes a servo write preparation heater positioner 210 (referred to hereinafter as a “positioner”) and a servo write preparation heater 220 (referred to hereinafter as a “heater”). The positioner 210, according to one embodiment, is configured to position the heater 220 over at least a portion of a surface of a disk. The heater 220, according to one embodiment, is configured to heat the portion of the disk's surface to prepare for servo write. Examples of heaters 220 include, but are not limited to, a heated metal plate, a laser or an ultraviolet lamp. In one embodiment, a laser type heater can produce a focused beam to heat a disk's surface or a portion of a disk's surface, among other things.

The apparatus 200 can be used to prepare the surface of a disk that is assembled into a disk drive or that is not assembled into a disk drive. The apparatus 200 can be used to prepare a single surface of a single disk, both surfaces of a single disk, or multiple surfaces of multiple disks, among other things.

The positioner 210 can position a heater 220 over a portion of a disk's surface or over the entire disk's surface. A magnetic field can be applied to the disk's surface to erase whatever magnetic field was originally on the disk's surface, for example, when the temperature of the disk's surface is approximately at the Curie point. Refer to the description under the heading “Curie Point,” among other places, for more information about the Curie point. Refer to the description under the heading “Erasing,” among other places, for more information about erasing. The positioner 210 can position the heater 220 over another portion of the disk's surface and the process of heating and erasing can be repeated. The positioner 210 can be used to position a heater 220 in proximity to a disk, to position a heater 220 in proximity to a portion of a disk's surface, to position heaters 220 in proximity to multiple disks' surfaces, to move one or more heaters 220 to different portions of one or more disks, to move one or more disks so that a different portion of the one or more disks is in proximity to the one or more heaters 220, or a combination thereof, among other things.

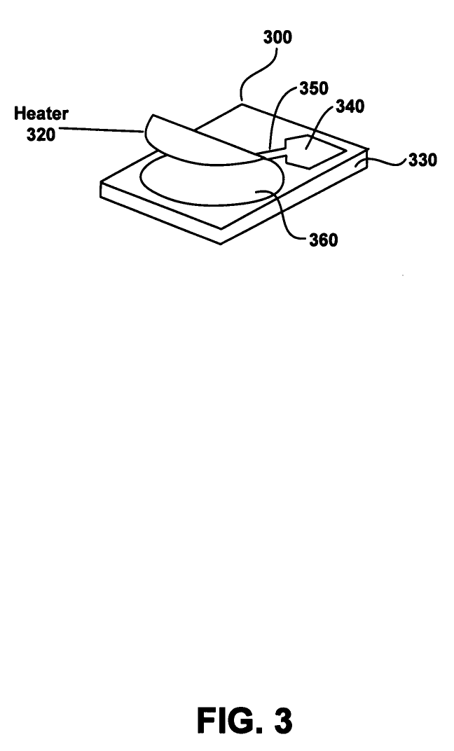

FIG. 3 depicts a single heater in relation to a single disk associated with an assembled disk drive, according to one embodiment. FIG. 3 depicts an exposed surface 360 of a disk that is in a disk drive 300, the voice coil motor 340, and a portion of the suspension arm 350. The heater 320 depicted in FIG. 3 is a portion of a metal plate. Heat generated by the metal plate 320 can heat the disk's surface 360.

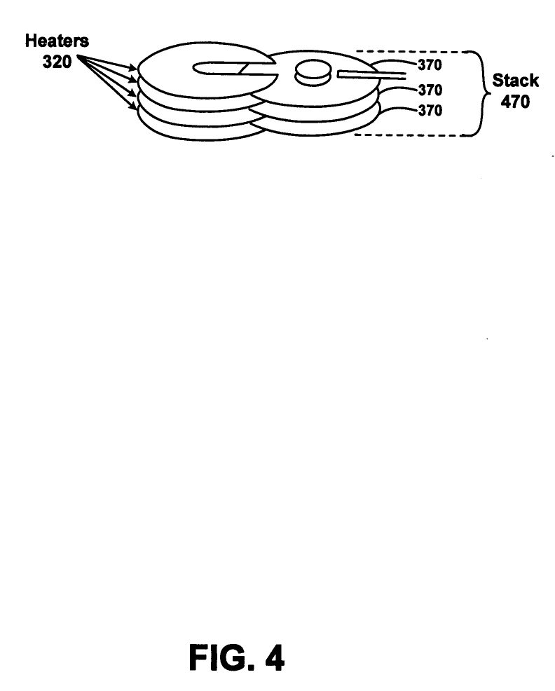

FIG. 4 depicts multiple heaters in relation to a stack of disks that are not assembled into a disk drive, according to one embodiment. The heaters 320 are metal plates that are positioned between the disks 370 associated with the stack 470.

### Method of Preparing for Servo Write

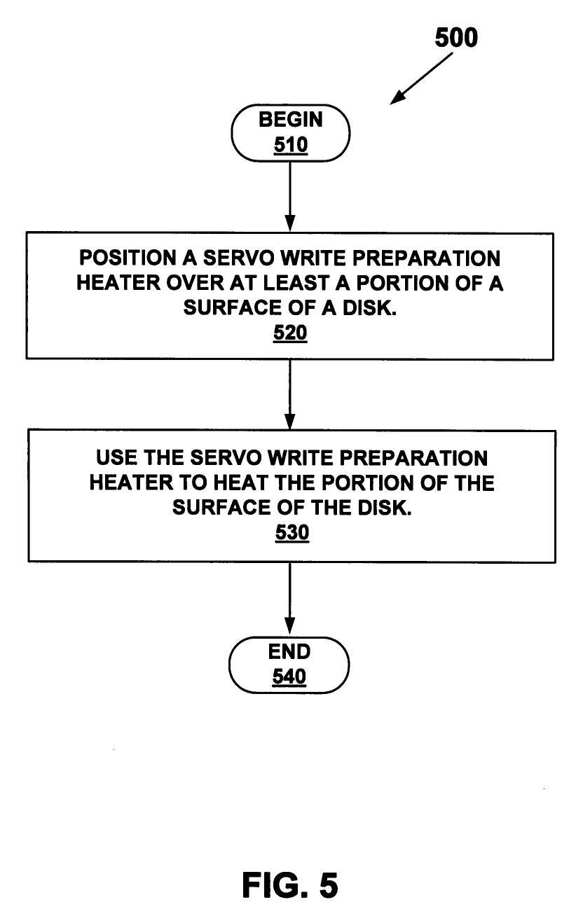

FIG. 5 depicts a flowchart 500 that describes a method of preparing for servo write, according to one embodiment. Although specific steps are disclosed in flowchart 500, such steps are exemplary. That is, embodiments of the present invention are well suited to performing various other steps or variations of the steps recited in flowchart 500. It is appreciated that the steps in flowchart 500 may be performed in an order different than presented, and that not all of the steps in flowchart 500 may be performed. The following description of flowchart 500 shall refer to FIGS. 2 and 3.

At step 510, the method begins

At step 520, a servo write preparation heater is positioned over at least a portion of a surface of a disk. For example, the positioner 210 (FIG. 2) can position a heated metal plate 320 (FIG. 3) in proximity to the disk's surface 360 so that a portion of the disk's surface 360 can be heated. The positioner 210 can also move the disk or the heated metal plate 320 so that another portion of the disk can be heated. Refer to the description under the heading “Apparatus for Preparing For Servo Write,” among other places, for more information on the positioner 210.

At step 530, the servo write preparation heater is used to heat the portion of the surface of the disk to prepare the surface for servo write. For example, the metal plate 320 can heat the portion of the disk's surface 360 that the metal plate 320 is in proximity to. The metal plate 320 can heat the portion of the disk's surface 360 to approximately the Curie point. Refer to the description under the heading “Curie Point,” among other places, for more information on the Curie point. Refer to the description under the heading “Apparatus for Preparing For Servo Write,” among other places, for more information on a heater.

At step 540, the method ends.

A write element can be used to write a new magnetic field to the heated portion of the disk's surface 360. The write element may be associated with the disk drive 300's read write head. Refer to the heading “Erasing,” among other places, for more information on erasing data from a portion of a disk's surface.

The process of positioning (520) a heater, heating (530) a portion of the disk's surface and erasing at least a subset of the magnetic field(s) associated with a heated portion can be repeated, for example, for another portion of the disk's surface. The process of positioning, heating, and erasing can be performed until all portions of a disk's surface, which are capable of being heated, have at least a subset of the data associated with those portions erased. The process of positioning, heating, and erasing can be performed until all or any subset of the data has been erased from the disk's surface.

One of ordinary skill in the art should realize that various embodiments of the present invention can be used in combination with longitudinal recording as well as perpendicular recording. Manufacturers are trying to make disk drives with higher and higher density. Smaller track widths are used to accomplish higher densities. Larger magnetic fields are used in order to successfully write data to the smaller track widths. Therefore, stronger magnetic fields are used to erase the data from the smaller track widths. Conventionally, the stronger magnetic fields result in longer periods of time to erase data from the high density disks. In contrast, various embodiments are well suited for high density recording because an increase in temperature results in lower coercivity, thus a smaller magnetic field can be used to erase data from a disk. The smaller magnetic field used by various embodiments to erase saves time in comparison to the conventionally stronger magnetic fields used to erase.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of preparing for servo write, the method comprising:
positioning a servo write preparation heater over at least a portion of a surface of a disk; and
using the servo write preparation heater to heat the portion of the surface of the disk to prepare the surface for the servo write.

2. The method as recited by claim 1, wherein the using of the servo write preparation heater to heat the portion of the surface of the disk further comprises:
using the servo write preparation heater to heat the portion of the surface of the disk to approximately a Curie point of at least one of the materials the disk is made of.

3. The method as recited by claim 2, wherein the using of the servo write preparation heater to heat the portion of the surface of the disk to approximately the Curie point further comprises:
using the servo write preparation heater to heat the portion of the surface of the disk to a temperature that is below the Curie point.

4. The method as recited by claim 1, further comprising:
applying a magnetic field to the heated portion of the surface of the disk.

5. The method as recited by claim 4, further comprising:
performing the servo write on the portion of the surface of the disk.

6. The method as recited by claim 1, wherein the positioning of the servo write preparation heater over the portion of the surface of the disk further comprises:
positioning a servo write preparation heater that is selected from a group consisting of a metal plate, a laser beam, and an ultraviolet lamp.

7. An apparatus for preparing for servo write, the apparatus comprising:
a servo write preparation heater positioner configured for positioning a servo write preparation heater over at least a portion of a surface of a disk; and
the servo write preparation heater configured for heating the portion of the surface of the disk to prepare the surface for the servo write.

8. The apparatus of claim 7, wherein the servo write preparation heater heats the portion of the surface of the disk to approximately a Curie point of at least one of the materials the disk is made of.

9. The apparatus of claim 8, wherein the servo write preparation heater heats the portion of the surface of the disk to approximately a temperature that is below the Curie point.

10. The apparatus of claim 7, wherein the servo write preparation heater heats the portion of the surface of the disk to a temperature that increases coercivity of a magnetic field associated with the portion of the surface of the disk but does not result in damage to the disk.

11. The apparatus of claim 7, wherein the apparatus further comprises a write element for applying a magnetic field to at least a subset of the heated portion of the surface of the disk.

12. The apparatus of claim 7, wherein the servo write preparation heater is a metal plate.

13. The apparatus of claim 7, wherein the servo write preparation heater is a laser beam.

14. The apparatus of claim 7, wherein the servo write preparation heater is an ultraviolet lamp.

15. The apparatus of claim 7, wherein the disk is associated with an assembled disk drive.

16. The apparatus of claim 7, wherein the disk is not assembled into a disk drive.

17. The apparatus of claim 7, wherein the servo write preparation heater positioner positions the servo write preparation heater over the portion of the surface of the disk by moving the servo write preparation heater.

18. The apparatus of claim 7, wherein the servo write preparation heater positioner positions the servo write preparation heater over the portion of the surface of the disk by moving the disk.

19. An apparatus for preparing for servo write, the apparatus comprising:
means for positioning a servo write preparation heater over at least a portion of a surface of a disk; and
means for heating the at least portion of the surface of the disk to prepare the surface for the servo write.

20. The apparatus of claim 19, the apparatus further comprising:
means for applying a magnetic field to at least a subset of the heated portion of the surface of the disk.
